(19) United States
(12) Patent Application Publication
(10) Pub. No.: US 2007/0199382 A1
(43) Pub. Date: Aug. 30, 2007

(54) Information processing apparatus and earthquake monitoring method

(76) Inventor: Akio Sakai, Tokyo (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/711,559

(22) Filed: Feb. 27, 2007

(30) Foreign Application Priority Data
Feb. 27, 2006 (JP) 2006-050599

(51) Int. Cl. G01V 1/00; G01H 5/00

(52) U.S. Cl. 73/645; 181/101

(57) ABSTRACT

According to one embodiment, an information processing apparatus includes a communication unit, an acceleration sensor, a detection unit configured to monitor an output signal from the acceleration sensor and to detect occurrence of an earthquake, and a notification unit configured to send, when the detection unit detects the occurrence of an earthquake, data relating to the detected earthquake to another predetermined information processing apparatus via the communication unit.

### CROSS-REFERENCE TO RELATED APPLICATIONS

This application is based upon and claims the benefit of priority from Japanese Patent Application No. 2006-050599, filed Feb. 27, 2006, the entire contents of which are incorporated herein by reference.

### BACKGROUND

1. Field

One embodiment of the invention relates to an earthquake monitoring technique which is realized by using an acceleration sensor that is mounted, for example, in a personal computer in order to protect a hard disk drive from shock.

2. Description of the Related Art

In recent years, computerization has been implemented in almost all kinds of industries, and various measures have been taken for securing data in case of an earthquake. An indispensable element in the measure to secure data is quick acquisition and collection of earthquake information. Various schemes for providing and acquiring earthquake information on a region-by-region basis have been proposed (see, e.g. Jpn. Pat. Appln. KOKAI Publication No. 2004-069310).

In addition, recently, in many companies, a WAN (Wide Area Network) has been constructed by connecting, over the Internet, LANs (Local Area Networks) which are provided in business offices. The protection of data, which makes use of the constructed WAN, has been conducted.

In the meantime, the protection of data using the WAN, is still at a level of so-called data backup, that is, saving of data between geographically distant points. At present, the acquisition itself of earthquake information depends on a third organization, as disclosed in Jpn. Pat. Appln. KOKAI Publication No. 2004-069310.

There has been a demand for the advent of a technique which enables use of resources, such as WANs constructed over the wire area, for earthquake monitoring, thereby to realize the measure for securing and protecting data.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 shows an example of the configuration of an earthquake monitoring system according to an embodiment of the present invention;

FIG. 2 shows an exemplary system configuration of an information processing apparatus according to the embodiment;

FIG. 3 shows an exemplary system configuration of a local server according to the embodiment;

FIG. 4 is an exemplary flow chart illustrating an operational procedure of the information processing apparatus in the earthquake monitoring system of the embodiment; and

FIG. 5 is an exemplary flow chart illustrating an operational procedure of the local server in the earthquake monitoring system of the embodiment.

### DETAILED DESCRIPTION

Various embodiments according to the invention will be described hereinafter with reference to the accompanying drawings. In general, according to one embodiment of the invention, an information processing apparatus includes a communication unit, an acceleration sensor, a detection unit configured to monitor an output signal from the acceleration sensor and to detect occurrence of an earthquake, and a notification unit configured to send, when the detection unit detects the occurrence of an earthquake, data relating to the detected earthquake to another predetermined information processing apparatus via the communication unit.

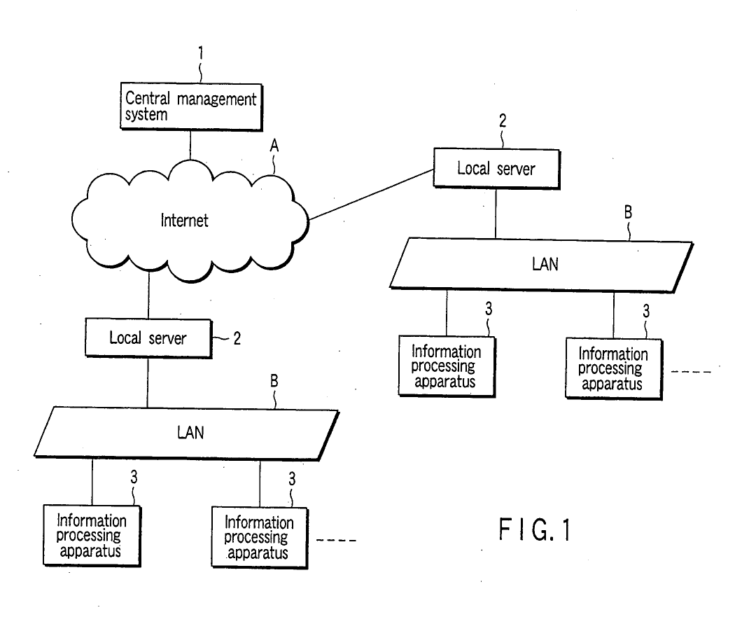

FIG. 1 shows an example of the configuration of an earthquake monitoring system according to an embodiment of the present invention. For example, a company having a plurality of business offices is now considered. A LAN B is an intra-office network provided in each business office.

A number of information processing apparatuses 3 are connected to the LAN B that is the intra-office network in each business office. The information processing apparatus 3 is a nonportable personal computer such as a desktop PC. The information processing apparatus 3 includes at least one hard disk drive.

The hard disk drive has a protection function of instantaneously retreating a data read/write head to an evacuation area at a time when the hard disk drive has begun to suffer some shock. In order to activate this protection function at a proper time, the information processing apparatus 3 is equipped with an acceleration sensor for sensing an acceleration that is caused in itself.

Paying attention to the fact that many information processing apparatuses 3 that are connected to the LAN B provided in each business office are equipped with acceleration sensors for protecting hard disk drives, this earthquake monitoring system makes use of the acceleration sensors, thereby realizing independent earthquake monitoring in each region. This point will be described below in detail.

The information processing apparatus 3, which monitors shaking by the acceleration sensor that is mounted for protecting the hard disk drive, determines occurrence of an earthquake when the shaking reaches a predetermined level and continues for a predetermined time period, and informs a local server 2 of the occurrence of the earthquake via the LAN B.

On the other hand, the local server 2, which has received the information about the occurrence of the earthquake, checks whether the information has been collected from, for example, a predetermined ratio or more of information processing apparatuses 3 which are connected to the LAN B.

If the information has been collected from the predetermined ratio or more of information processing apparatuses 3, the local server 2 informs a central management system 1 of the occurrence of the earthquake in the associated region over the Internet A. Thus, the central management system 1 quickly collects the earthquake information of each region by the independent network.

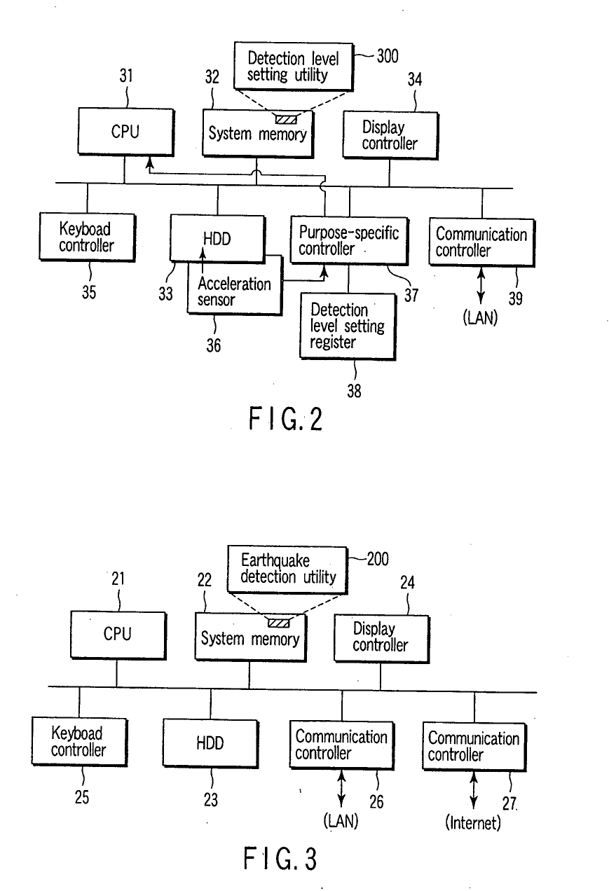

FIG. 2 shows an exemplary system configuration of the information processing apparatus 3. As shown in FIG. 2, the information processing apparatus 3 includes a CPU 31, a system memory 32, a hard disk drive (HDD) 33, a display controller 34, a keyboard controller 35, an acceleration sensor 36, a purpose-specific controller 37, a detection level setting register 38 and a communication controller 39.

The CPU 31 executes an overall control of the information processing apparatus 3, and executes various programs which are stored in the system memory 32. A detection level setting utility 300 (to be described later) is one of the programs that are executed by the CPU 31.

The system memory 32 is memory media serving as a main memory of the information processing apparatus 3, and stores programs which are executed by the CPU 31, and data associated with these programs. On the other hand, the hard disk drive 33 is storage media serving as an external memory of the information processing apparatus 3, and stores a great amount of programs and data as an auxiliary device of the system memory 32.

The display controller 34 controls the output side of a user interface which is provided by the information processing apparatus 3. The display controller 34 executes a display control of images associated with the program that is executed by the CPU 31. On the other hand, the keyboard controller 35 controls the input side of the user interface which is provided by the information processing apparatus 3. The keyboard controller 35 generates data corresponding to a user's keyboard operation, and sends it to the CPU 31.

The acceleration sensor 36 is a sensor which varies the level of an output signal in accordance with an acceleration which is applied to the acceleration sensor 36. If an output signal of a predetermined level or above is output from the acceleration sensor 36, the hard disk drive 33 immediately retreats its head to an evacuation position. The output signal of the acceleration sensor 36 is also supplied to the purpose-specific controller 37.

If the level of the output signal of the acceleration sensor 36 varies with a predetermined range or more and this variation continues for a predetermined time period or more, the purpose-specific controller 37 determines the occurrence of an earthquake and generates an interrupt to the CPU 31.

The detection level setting register 38 is a register which stores a reference value, on the basis of which the purpose-specific controller 37 determines occurrence of an earthquake. In other words, if a variation exceeding the level range, which is set by the detection level setting register 38, appears on the level of the output signal of the acceleration sensor 36 for a predetermined time or more, the purpose-specific controller 37 determines occurrence of an earthquake.

The detection level setting utility 300 is a utility program which enables a user to arbitrarily set the reference value that is to be stored in the detection level setting register 38. The detection level setting utility 300 is used in order to cancel a variation due to ambient conditions, for example, by increasing the level range when the information processing apparatus 3 is situated at a place where a traffic amount is large and vibration is easily applied to the information processing apparatus 3.

The communication controller 39 executes and controls data communication via the LAN B. The CPU 31, which has received an interrupt from the purpose-specific controller 37, temporarily halts a process which is being executed and executes, with first priority, a process of informing the local server 2 of the occurrence of an earthquake via the communication controller 39. The information from the CPU 31 includes the output signal from the acceleration sensor 36.

FIG. 3 shows an exemplary system configuration of the local server 2. As shown in FIG. 3, the local server 2 includes a CPU 21, a system memory 22, a hard disk drive (HDD) 23, a display controller 24, a keyboard controller 25, and communication controllers 26 and 27.

The CPU 21 executes an overall control of the local server 2, and executes various programs which are stored in the system memory 22. An earthquake detection utility 200 (to be described later) is one of the programs that are executed by the CPU 21.

The system memory 22 is memory media serving as a main memory of the local server 2, and stores programs which are executed by the CPU 21, and data associated with these programs. On the other hand, the hard disk drive 23 is storage media serving as an external memory of the local server 2, and stores a great amount of programs and data as an auxiliary device of the system memory 22.

The display controller 24 controls the output side of a user interface which is provided by the local server 2. The display controller 24 executes a display control of images associated with the program that is executed by the CPU 21. On the other hand, the keyboard controller 25 controls the input side of the user interface which is provided by the local server 2. The keyboard controller 25 generates data corresponding to the user's keyboard operation, and sends it to the CPU 21.

The communication controller 26 executes and controls data communication via the LAN B. On the other hand, the communication controller 27 executes and controls data communication via the Internet A. Information on the occurrence of an earthquake, which is transmitted from the information processing apparatus 3, is received by the communication controller 26 and is delivered to the earthquake detection utility 200 that is executed by the CPU 21.

In the case where this information is collected, for example, from a predetermined ratio of information processing apparatuses 3 which are connected to the LAN B, the earthquake detection utility 200 determines occurrence of an earthquake and informs the central management system 1 of the occurrence of earthquake via the communication controller 27. This information includes the output signal of the acceleration sensor 36, which is collected from each information processing apparatus 3.

With the provision of the earthquake detection utility 200, erroneous information to the central management system 1 is avoided even if, for instance, one information processing apparatus 3 on the LAN B erroneously detects occurrence of an earthquake. Therefore, the accuracy of the entire earthquake monitoring system can be enhanced.

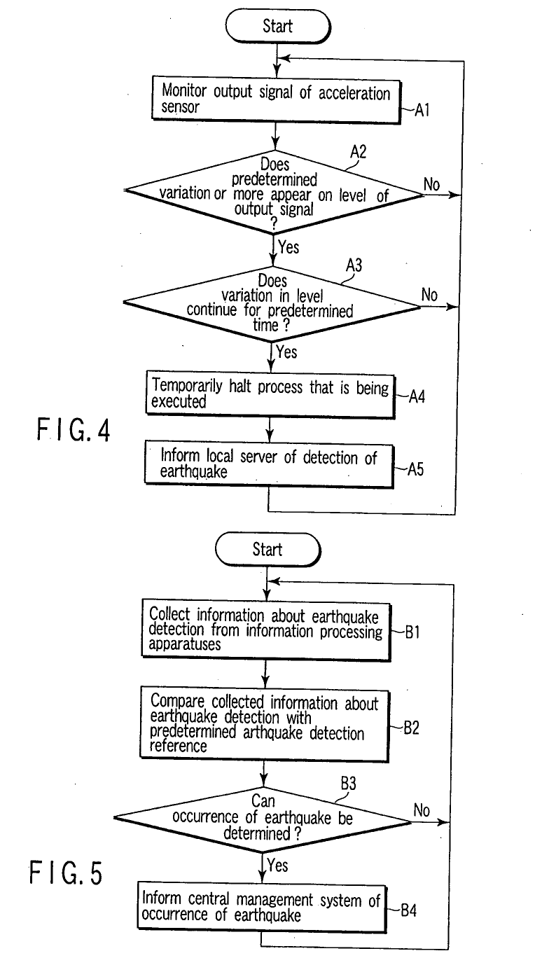

FIG. 4 is an exemplary flow chart illustrating the operational procedure of the information processing apparatus 3 in the earthquake monitoring system of the present embodiment.

The purpose-specific controller 37 monitors the output signal from the acceleration sensor 36 (block A1) and determines whether a variation exceeding the level range, which is set in the detection level setting register 38, appears on the output signal of the acceleration sensor 36 (block A2).

If a variation exceeding the level range, which is set in the detection level setting register 38, appears on the output signal of the acceleration sensor 36 (YES in block A2), the purpose-specific controller 37 determines whether the variation continues for a predetermined time or more (block A3).

If the variation continues for the predetermined time or more (YES in block A3), the purpose-specific controller 37 generates an interrupt to the CPU 31. The CPU 31, which has received the interrupt, temporarily halts a process which is being executed (block A4) and informs the local server 2 of the occurrence of an earthquake via the communication controller 39 (block A5).

FIG. 5 is an exemplary flow chart illustrating the operational procedure of the local server 2 in the earthquake monitoring system of the present embodiment.

The earthquake detection utility 200 collects via the communication controller 26 the information about the earthquake detection from information processing apparatuses 3 over the LAN B (block B1), and compares the collected information with a predetermined earthquake detection reference (block B2), thereby determining occurrence/non-occurrence of an earthquake in the associated region (block B3).

If the collected result of the information on the occurrence of earthquake can be determined to indicate the occurrence of earthquake (YES in block B3), the earthquake detection utility 200 informs the central management system 1 of the occurrence of an earthquake in the associated region via the communication controller 27 (block B4).

As has been described above, the earthquake monitoring system of the present embodiment can realize independent comprehension of the condition of earthquake occurrence in each region over the network to which personal computers, which are discretely disposed in the respective regions, are connected.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information processing apparatus comprising:
a communication unit;
an acceleration sensor;
a detection unit configured to monitor an output signal from the acceleration sensor and to detect occurrence of an earthquake; and
a notification unit configured to send, when the detection unit detects the occurrence of an earthquake, data relating to the detected earthquake to another predetermined information processing apparatus via the communication unit.

2. The information processing apparatus according to claim 1, wherein the acceleration sensor is a sensor which varies a level of an output signal in accordance with a detected acceleration, and
the information processing apparatus further comprises a setting unit configured to set a reference level, with which the detection unit compares the output signal of the acceleration sensor, thereby to determine the occurrence/non-occurrence of an earthquake.

3. The information processing apparatus according to claim 1, wherein the notification unit temporarily halts a process which is being executed by the information processing apparatus, and executes transmission of data relating to the earthquake.

4. The information processing apparatus according to claim 1, wherein the acceleration sensor is attached in order to protect a hard disk drive, which is mounted in the information processing apparatus, against shock.

5. An information processing apparatus comprising:
a communication unit;
a collection unit configured to collect, via the communication unit, data relating to an earthquake, which is detected by at least one other information processing apparatus in each of associated regions;
a determination unit configured to determine occurrence/non-occurrence of an earthquake in the respective regions on the basis of the data relating to an earthquake, which is collected by the collection unit; and
a notification unit configured to transmit, when the determination unit determines the occurrence of an earthquake, the data relating to the earthquake, which is collected by the collection unit, as earthquake information of each of the associated regions to another predetermined information processing apparatus via the communication unit.

6. The information processing apparatus according to claim 5, wherein the determination unit determines the occurrence/non-occurrence of an earthquake on the basis of a relationship between a number of other information processing apparatuses in the same region and a number of collected data relating to the earthquake from the region.

7. The information processing apparatus according to claim 6, further comprising a setting unit configured to set a relationship between the number of other information processing apparatuses and the number of collected data relating to the earthquake, the relationship being used as a reference on the basis of which the determination unit determines the occurrence/non-occurrence of the earthquake.

8. An earthquake monitoring method of an information processing apparatus including a communication unit and an acceleration sensor, the method comprising:
monitoring an output signal from the acceleration sensor and detecting occurrence of an earthquake; and
sending, when the occurrence of an earthquake is detected, data relating to the detected earthquake to another predetermined information processing apparatus via the communication unit.

9. The earthquake monitoring method of an information processing apparatus, according to claim 8, wherein the acceleration sensor is a sensor which varies a level of an output signal in accordance with a detected acceleration, and
the method further comprises setting a reference level, with which the output signal of the acceleration sensor is compared, thereby to determine the occurrence/non-occurrence of an earthquake.

10. The earthquake monitoring method of an information processing apparatus, according to claim 8, wherein the sending executes transmission of the data relating to the earthquake with first priority by temporarily halting a process which is being executed, when the occurrence of the earthquake is detected.
